(19) United States
(12) Patent Application Publication
(10) Pub. No.: US 2006/0001890 A1
(43) Pub. Date: Jan. 5, 2006

(54) Spatial light modulator as source module for DUV wavefront sensor

(75) Inventor: Sherman K. Poultney, Wilton, CT (US)

Correspondence Address: STERNE, KESSLER, GOLDSTEIN & FOX P.L.L.C., 1100 NEW YORK AVE., N.W., WASHINGTON, DC, 20005, US

(73) Assignee: ASML Holding N.V., Veldhoven (NL)

(21) Appl. No.: 10/882,295

(22) Filed: Jul. 2, 2004

(51) Int. Cl. G03H 1/02

(52) U.S. Cl. 356/521

(57) ABSTRACT

A wavefront measurement system with a source of electromagnetic radiation and an illumination system that directs the electromagnetic radiation to a spatial light modulator to produce a diffraction pattern. A projection optical system projects an image of the spatial light modulator onto an image plane. A shearing grating is in the image plane. A detector receives a fringe pattern from the image plane. The spatial light modulator can generate a non-linear phase variation across it to scan the diffraction pattern across a pupil of the projection optical system. The spatial light modulator forms a synthetic grating. The spatial light modulator can be a transmissive-type or a reflective-type modulator. Pixels of the spatial light modulator form rulings of a synthetic grating that can have random variations of transmission and/or angular orientation within each ruling. The spatial light modulator can simulate lateral movement of the synthetic grating, or form a synthetic grating with different orientations of its rulings.

### BACKGROUND OF THE INVENTION

1. Field of the Invention

The present invention relates generally to lithography. More particularly, the present invention relates to a wavefront sensor by means of shearing grating in image plane and CCD array in its farfield for use in lithographic applications.

2. Related Art

Lithography is a process used to create features on the surface of substrates. Such substrates can include those used in the manufacture of flat panel displays (e.g., liquid crystal displays), circuit boards, various integrated circuits, and the like. A frequently used substrate for such applications is a semiconductor wafer or glass substrate. While this description is written in terms of a semiconductor wafer for illustrative purposes, one skilled in the art would recognize that this description also applies to other types of substrates known to those skilled in the art.

During lithography, a wafer, which is disposed on a wafer stage, is exposed to an image projected onto the surface of the wafer by exposure optics located within a lithography apparatus. While exposure optics are used in the case of photolithography, a different type of exposure apparatus can be used depending on the particular application. For example, x-ray, ion, electron, or photon lithography each can require a different exposure apparatus, as is known to those skilled in the art. The particular example of photolithography is discussed here for illustrative purposes only.

The projected image produces changes in the characteristics of a layer, for example photoresist, deposited on the surface of the wafer. These changes correspond to the features projected onto the wafer during exposure. Subsequent to exposure, the layer can be etched to produce a patterned layer. The pattern corresponds to those features projected onto the wafer during exposure. This patterned layer is then used to remove or further process exposed portions of underlying structural layers within the wafer, such as conductive, semiconductive, or insulative layers. This process is then repeated, together with other steps, until the desired features have been formed on the surface, or in various layers, of the wafer.

Conventional lithographic systems and methods form images on a semiconductor wafer. The system typically has a lithographic chamber that is designed to contain an apparatus that performs the process of image formation on the semiconductor wafer. The chamber can be designed to have different gas mixtures and grades of vacuum depending on the wavelength of light being used. A reticle is positioned inside the chamber. A beam of light is passed from an illumination source (located outside the system) through an optical system, an image outline on the reticle, and a second optical system before interacting with a semiconductor wafer.

A plurality of reticles are required to fabricate a device on the substrate. These reticles are becoming increasingly costly and time consuming to manufacture due to the feature sizes and the exacting tolerances required for small feature sizes. Also, a reticle can only be used for a certain period of time before being worn out. Further costs are routinely incurred if a reticle is not within a certain tolerance or when the reticle is damaged. Thus, the manufacture of wafers using reticles is becoming increasingly, and possibly prohibitively expensive.

In order to overcome these drawbacks, maskless (e.g., direct write, digital, etc.) lithography systems have been developed. The maskless system replaces a reticle with a variable contrast device called a spatial light modulator (SLM). Known SLMs include a digital mirror device (DMD), a liquid crystal display (LCD), a grating light valves device (GLV), or the like. The SLM includes an array of active areas (e.g., tilting and/or pistoning mirrors or greytoning LCD array cells) that vary optical properties in a controlled fashion to form a desired pattern.

The problem of measuring the undesirable perturbations of the wavefront (often referred to as wavefront aberrations) is a persistent one for the lithographic applications. These wavefront aberrations result from various physical causes, such as changes in refractive or reflective properties of the optical elements (lenses or mirrors) occurring as a result of mechanical displacements or deformations, or changes in the optical properties of the optical elements caused by heating, or light-induced compaction. In particular, it is desirable to be able to measure wavefront quality in the photolithographic tool during wafer production and exposure, rather than having to take the tool offline in order to do so, which increases cost of ownership, reduces through-put or introduces some other type of inefficiency.

Interferometric systems that use two gratings—one in the image plane of the projection optics, and one in the object plane of the projection optics, can be used to measure wavefront aberrations in lithographic systems. However, lithographic systems that use spatial light modulators have a particular problem: unlike conventional systems that use reticles as masks, spatial light modulators are relatively fragile, and are not routinely moved in and out of the object plane. This can be contrasted with conventional reticles and gratings, where different sets of reticles and gratings are routinely placed on a reticle stage, and are moved in and out of the object plane. Moving the relatively fragile SLM in and out of the object plane so as to replace it with an object plane grating is a relatively complex procedure that should be avoided at all costs.

Accordingly, there is a need in the art for aberration measurement for optical systems that utilize spatial light modulators without a risk of damaging the SLM.

### SUMMARY OF THE INVENTION

The present invention is directed to a spatial light modulator for use in a wavefront sensor that substantially obviates one or more of the problems and disadvantages of the related art.

One aspect includes a wavefront measurement system with a source of electromagnetic radiation and an illumination system that directs the electromagnetic radiation to a spatial light modulator to produce a diffraction pattern. A projection optical system projects an image of the spatial light modulator onto an image plane. A shearing grating is in the image plane. A detector receives a fringe pattern from the image plane. The detector is located in a plane that is optically conjugate with a pupil of the projection optical system. The spatial light modulator can generate a non-linear phase variation across it to scan the diffraction pattern across a pupil of the projection optical system. The spatial light modulator forms a synthetic grating, and can be a transmissive-type or a reflective-type modulator. Pixels of the spatial light modulator form rulings, or “stripes” of a synthetic grating that can also have random variations of transmission and/or angular orientation within each ruling. The spatial light modulator can simulate lateral movement of the synthetic grating. The spatial light modulator can form a synthetic grating with different (e.g., orthogonal) orientations of its rulings.

In another aspect, a method of measuring a wavefront of an optical system includes: (1) generating electromagnetic radiation at a source; (2) delivering the electromagnetic radiation to a spatial light modulator; (3) forming a diffraction pattern at the spatial light modulator; (4) scanning the diffraction pattern across a pupil of an optical system; (5) receiving an image of the source; and (6) determining wavefront parameters from the image.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate embodiments of the invention and together with the description serve to explain the principles of the invention. In the drawings:

FIG. 1 shows a maskless lithography system having reflective spatial light modulators.

FIG. 2 shows a maskless lithography system having transmissive spatial light modulators.

FIG. 3 shows another illustration of a spatial light modulator according to an embodiment of the present invention.

FIG. 4 shows more details of the spatial light modulator of FIG. 3.

FIG. 5 shows a two-dimensional array of the spatial light modulator according to one embodiment of the present invention.

FIG. 6 illustrates a portion of a reflective SLM according to one embodiment of the present invention.

FIG. 7 illustrates a field in a pupil of the projection optics for ten different tilt values for a small numerical aperture projection optics.

FIG. 8 illustrates a field in the projection optics image plane that corresponds to FIG. 7.

FIG. 9 shows a portion of an exemplary photolithographic system of the present invention.

FIGS. 10 and 11 illustrate the use of an interferometer to produce shear wavefronts.

FIG. 12 illustrates an example of interference fringes as they appear at the focal plane with the use of the present invention.

### DETAILED DESCRIPTION OF EMBODIMENTS OF THE INVENTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

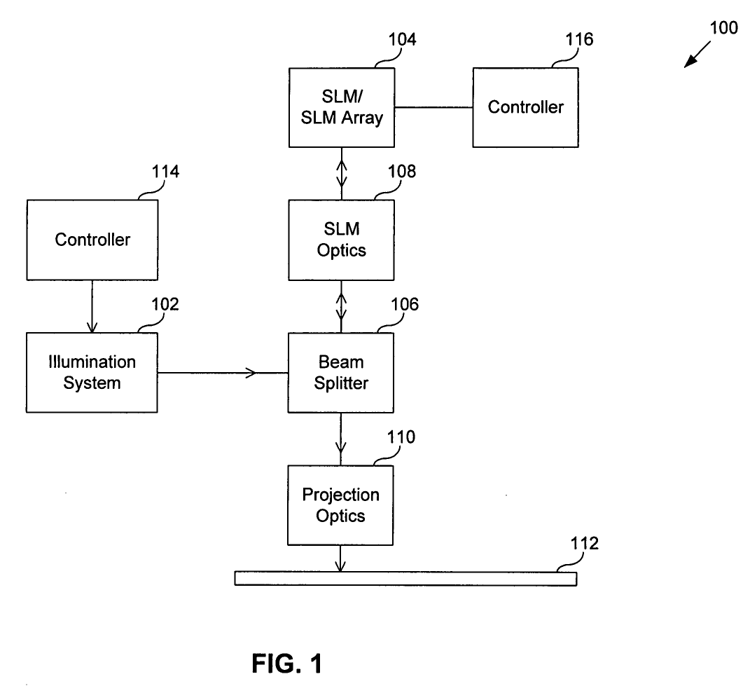

FIG. 1 shows a maskless lithography system 100 according to an embodiment of the present invention. System 100 includes an illumination system 102 that transmits light to a reflective spatial light modulator (SLM) 104 (e.g., a digital micromirror device (DMD), a reflective liquid crystal display (LCD), or the like) via a beam splitter 106 and SLM optics 108. SLM 104 is used to pattern the light in place of a reticle used in traditional lithography systems. Patterned light reflected from SLM 104 is passed back through beam splitter 106, then through projection optics (PO) 110 and is used to create an image of a circuit pattern on an object 112 (e.g., a substrate, a semiconductor wafer, a glass substrate for a flat panel display, or the like).

It is to be appreciated that illumination optics can be housed within illumination system 102, as is known in the relevant art. It is also to be appreciated that SLM optics 108 and projection optics 110 can include any combination of optical elements required to direct light onto desired areas of SLM 104 and/or object 112, as is known in the relevant art.

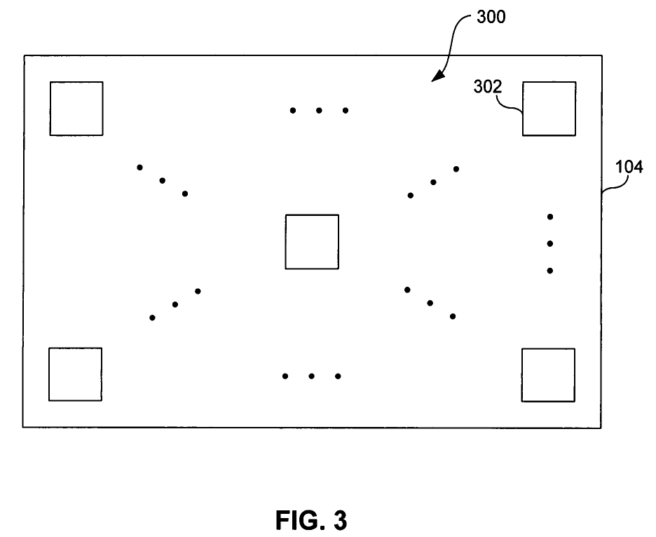

In alternative embodiments, either one or both of illumination system 102 and SLM 104 can be coupled to or have integral controllers 114 and 116, respectively. Controller 114 can be used to adjust illumination source 102 based on feedback from system 100 or to perform calibration. Controller 116 can also be used for adjustment and/or calibration. Alternatively, controller 116 can be used for controlling active devices (e.g., pixels, mirrors, locations, etc.) 302 (see FIG. 3, discussed below) on SLM 104, to generate a pattern used to expose object 112. Controller 116 can either have integral storage or be coupled to a storage element (not shown) with predetermined information and/or algorithms used to generate the pattern or patterns.

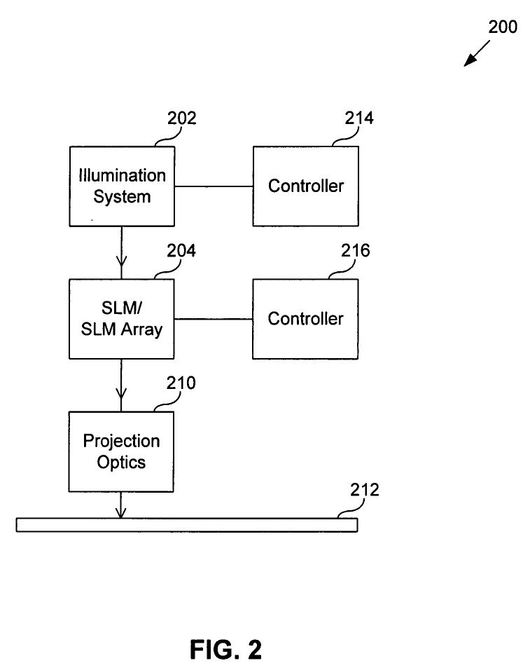

FIG. 2 shows a maskless lithography system 200 according to a further embodiment of the present invention. System 200 includes an illumination source 202 that transmits light through a SLM 204 (e.g., a transmissive LCD, or the like) to pattern the light. The patterned light is transmitted through projection optics 210 to write the pattern on a surface of an object 212. In this embodiment, SLM 204 is a transmissive SLM, such as a liquid crystal display, or the like. Similar to above, either one or both of illumination source 202 and SLM 204 can be coupled to or integral with controllers 214 and 216, respectively. Controllers 214 and 216 can perform similar functions as controller 114 and 116 described above, and as known in the art.

Example SLMs that can be used in systems 100 or 200 are manufactured by Micronic Laser Systems AB of Sweden and Fraunhofer Institute for Circuits and Systems of Germany. A grating light valve (GLV) SLM, such as manufactured by Silicon Light Machines, of Sunnyvale, Calif., another example of an SLM where the present invention is applicable.

Merely for convenience, reference will be made only to system 100 below. However, all concepts discussed below can also apply to system 200, as would be known to someone skilled in the relevant arts. The present invention is applicable to such systems as well.

FIG. 3 shows details of an active area 300 of SLM 104. Active area 300 includes an array of active devices 302 (represented by dotted patterns in the figure). Active devices 302 can be mirrors on a DMD or locations on a LCD. It is to be appreciated that active devices 302 can also be referred to as pixels, as is known in the relevant art. By adjusting the physical characteristics of active devices 302, they can be seen as being either ON or OFF (for a binary SLM) or a state in-between ON and OFF for other SLMs. Digital or analog input signals based on a desired pattern are used to control various active devices 302. In some embodiments, an actual pattern being written to object 112 can be detected and a determination can be made whether the pattern is outside an acceptable tolerance.

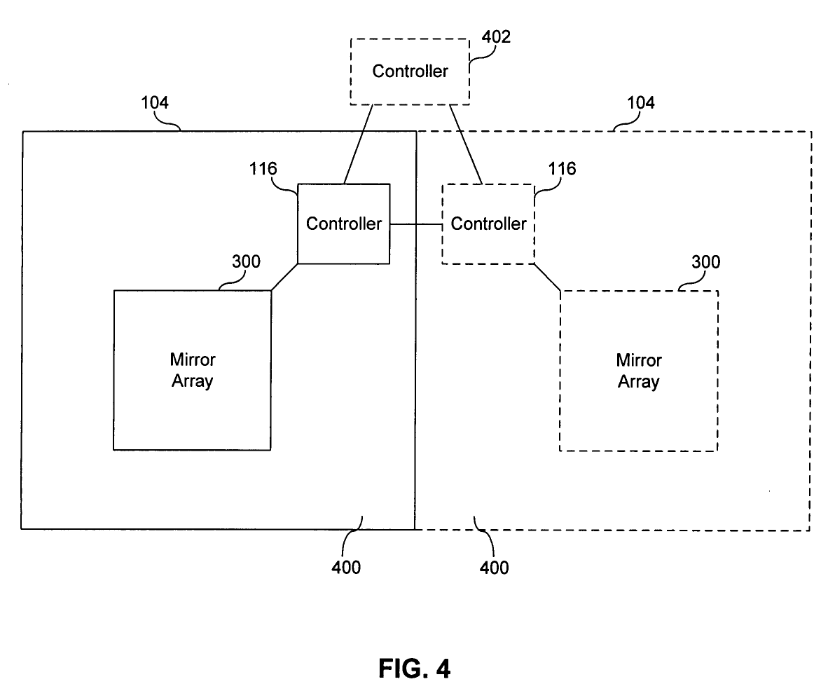

FIG. 4 illustrates further details of SLM 104. SLM 104 can include an inactive packaging 400 surrounding active area 300. Also, in an alternative embodiment, a main controller 402 can be coupled to several SLM controllers 116 to monitor and control an array of SLMs. Also, adjacent SLMs may be offset or staggered with respect to each other.

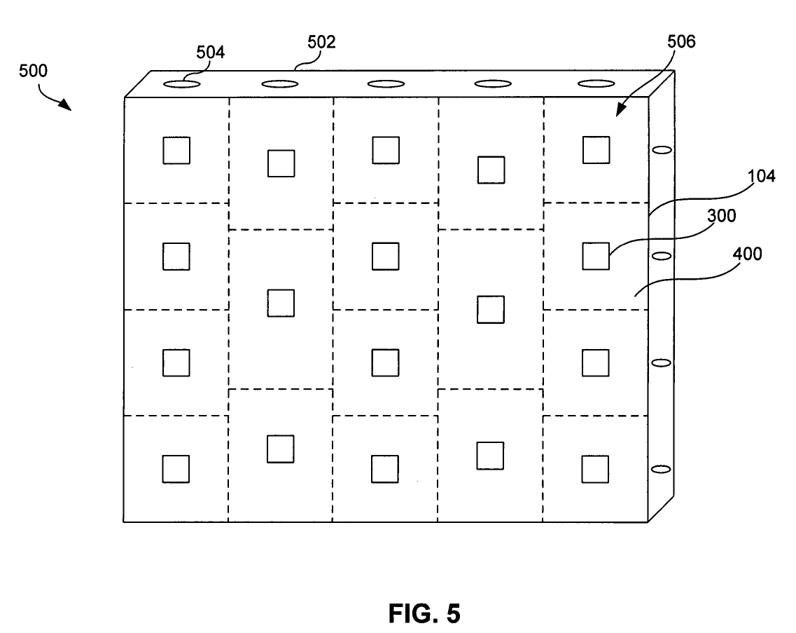

FIG. 5 shows an assembly 500 including a support device 502 that receives an array of SLMs 104. In various embodiments, as described in more detail below, the array of SLMs 104 can have varying numbers of columns, rows, SLMs per column, SLMs per row, etc., based on a number of desired exposures per pulse, or other criteria of a user. The SLMs 104 can be coupled to a support device 502. Support device 502 can have thermal control areas 504 (e.g., water or air channels, etc.), areas for control logic and related circuitry (e.g., see FIG. 4 showing elements 116 and element 402, which can be ASICs, A/D converters, D/A converters, fiber optics for streaming data, etc.), and windows 506 (formed within the dashed shapes) that receive SLMs 104, as is known in the relevant art. Support device 502, SLMs 104, and all peripheral cooling or control devices are referred to as an assembly. Assembly 500 can allow for a desired step size to produce the desired stitching (e.g., connecting of adjacent elements of features on object 112) and overlap for leading and trailing SLMs 104. By way of example, support device 502 can have dimensions of 250 mm×250 mm (12 in×12 in) or 300 mm×300 mm (10 in×10 in). Support device 502 can be used for thermal management based on being manufactured from a temperature stable material.

Support device 502 can be utilized as a mechanical backbone to ensure spacing control of SLMs 104 and for embedding the circuitry and the thermal controls areas 504. Any electronics can be mounted on either or both of a backside and front side of support device 502. For example, when using analog based SLMs or electronics, wires can be coupled from control or coupling systems 504 to active areas 300. Based on being mounted on support device 502, these wires can be relatively shorter, which reduces attenuation of analog signals compared to a case where the circuitry is remote from the support device 502. Also, having short links between the circuitry and active areas 300 can increase communication speed, and thus increase pattern readjustment speed in real time.

Alternatively, when SLM 104 or electrical devices in the circuitry wear out, assembly 500 can easily be replaced. Although it would appear replacing assembly 500 is more costly than just a chip on assembly 500, it is in fact easier and quicker to replace the entire assembly 500, which can save production costs. Also, assembly 500 can be refurbished, allowing for a reduction in replacement parts if end users are willing to use refurbished assemblies 500. Once assembly 500 is replaced, only verification of the overall alignment is needed before resuming fabrication. In some examples, kinematic mounting techniques can be used to allow for repeatable mechanical alignments of assembly 500 during field replacements. This may eliminate a need for any optical adjustment of assembly 500.

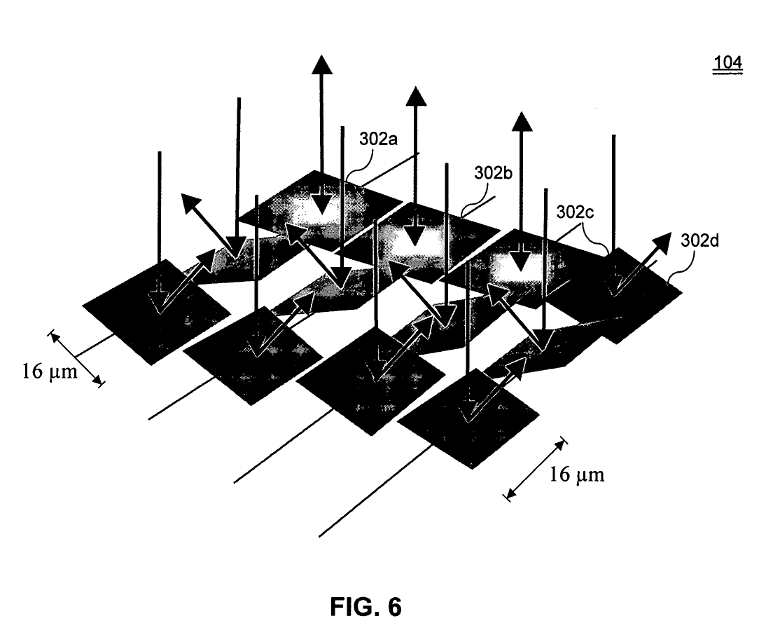

Current SLM systems typically utilize 16 μm×16 μm pixels 302 (see FIG. 6), with next generation SLM systems moving to 8×8 μm pixels 302. A typical SLM 104 contains over a million pixels 302, wherein the properties of each pixel 302 are individually controlled by a voltage applied individually to each pixel 302. Note that SLM 104 can be both reflective and transmissive (for example, mirror type reflective SLMs, and LCD type transmissive SLMs). Reflective SLMs 104 are more commonly used in the industry today. FIG. 6 is an illustration of such a reflective, or tilting, type SLM 104, showing twelve pixels (of which 302a-302d are labeled). In one example, a capacitive coupling (not shown) is controlled using a transistor (not shown). A typical pixel 302 is controlled in a fashion similar to how parallel plates in a capacitor are controlled, in other words, a capacitive coupling is used to control the tilt of the mirrors of the pixels 302 using electrostatic forces. In FIG. 6, one of the mirrors (mirror of pixel 302d), is shown as tilted when the capacitor under that mirror is charged.

If the pixel 302 is a square, its diffraction pattern is a sinc function, defined by

$$\frac{sin ( x )}{x} ,$$

with a large zeroth order lobe, and smaller side lobes. When a pixel 302 is tilted, the diffraction pattern from the pixel 302 shifts an angular space to the side.

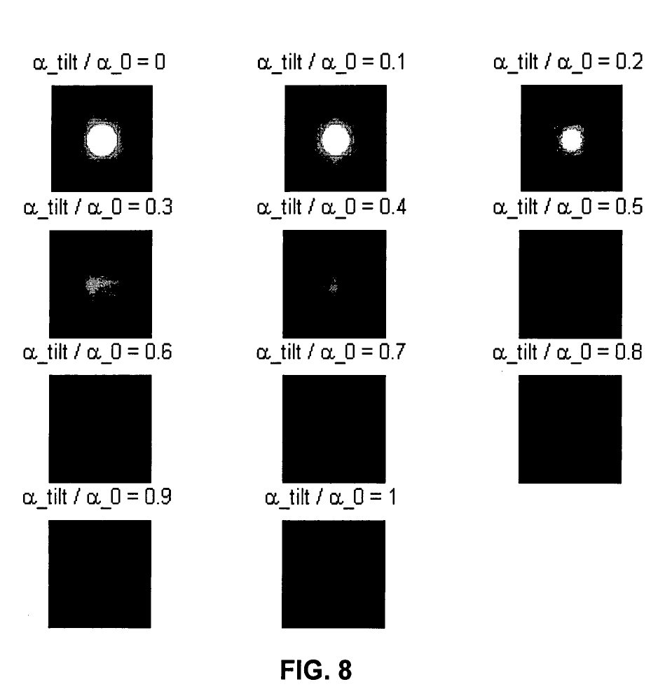

If the projection optics 110 only captures a portion of the zeroth order lobe, for example, ½ or ⅓ of the total amount of energy in the zeroth order lobe (i.e., using the PO 110 that leaves an individual SLM pixel un-resolved), then tilting the pixel 302d modulates the amount of light passing through the projection optics 110. Thus, it is essential for the modulation mechanism that the pixel 302d not be resolved, in order to have a modulation effect. However, because the pixel 302d is not resolved, instead of seeing a “sharp square” (for a square pixel or mirror), a “blob” of light (see FIG. 8, discussed below) will be imaged, and will exceed the nominal dimensions of the “sharp square” by several times. Thus, images from neighboring pixels 302 will overlap. The neighboring pixels 302 therefore will strongly interact with each other. This means that at each point in the image plane, light is received from several pixels 302.

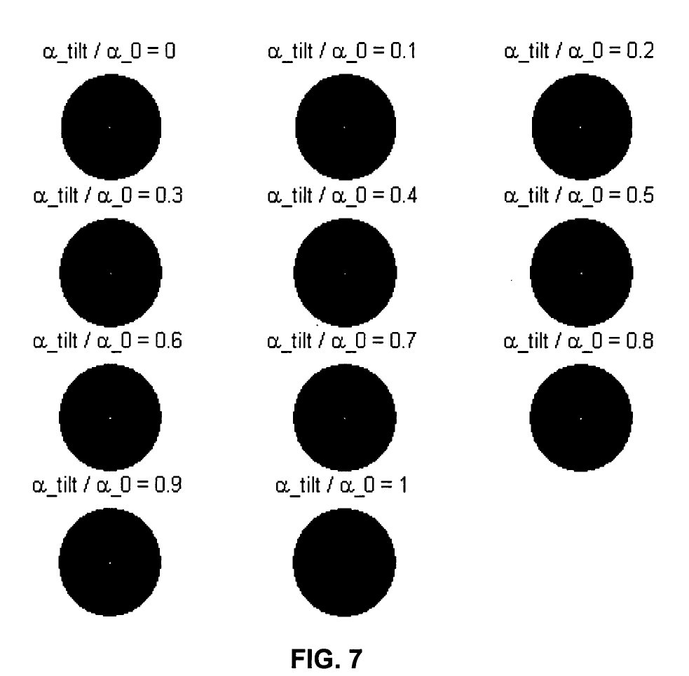

For the example illustrated in FIGS. 7-8, exemplary λ (source wavelength)=193.375 nm, exemplary L (pixel dimension)=16 μm, exemplary NA (numerical aperture) of the PO=0.00265, the pixel 302 tilts between α=0 and

$$α = {α}_{0} = \frac{λ}{2 * L} .$$

FIG. 7 shows the size of the diffracted spot in the input pupil plane and shows the input NA of the PO as the small center dot. Thus, FIG. 7 illustrates the field in the pupil of the projection optics 110 for ten different tilt angles for a single pixel (note that in FIGS. 7 and 8 angular modulation of only one pixel is illustrated for clarity). With a numerical aperture of 0.00265, the SLM pixel is very poorly resolved (i.e., sub-resolved) in the image plane (see FIG. 8). Specifically, as shown in FIG. 8, although there is good modulation for the different tilt angles α, the image of the pixel 302 is very “spread out.”

As noted above, there are a number of physical principles that can be used to modulate the light using an SLM. One of the principles is the use of graytone, or transmissive SLMs where the intensity of the transmitted light through each pixel is modulated. Another principle is the tilting mirror principle, or tilting SLMs, where the angle of each pixels mirror is controlled, usually digitally. A third type of principle for modulating SLM output is the use of pistoning, or moving mirrors, which introduce phase variation into the reflected wave front. All of these types of SLMs may be used in the present invention.

It is convenient to characterize field-dependent aberrations of a projections optics by an aberration of a wavefront of a spherical wave emitted from a corresponding field point in the object plane. Various interferometry techniques can be used to measure aberration of this spherical wave. Shearing interferometry based on an extended incoherent source in the object plane superimposed with an object-plane grating matching the shearing (image plane) grating is described in J. Braat and A. J. E. M. Janssen, Improved Ronchi test with Extended Source, J. Opt. Soc. Am. A, Vol. 16, No. 1, pp. 131-140, January 1999, which is incorporated by reference herein. A shear ratio, further discussed below, is a measure of how much the numerical aperture of the projection optics 110 is “shifted over” laterally by the image space grating.

Given that moving the spatial light modulator 104 in and out of the object plane, to replace it with an object space grating, is usually impractical, it is nonetheless possible to use the SLM 104 itself as a optical element that functions equivalently to a grating, in effect forming a “synthetic grating.” Note that the magnification of the projection optics 110 in SLM-based lithographic systems is typically much larger than it is in reticle-based lithographic systems. Reticle-based lithographic systems are typically on the order of about 5× magnification, whereas SLM-based maskless lithographic systems can be on the order of 200-350× magnification. This needs to be taken into account when designing the corresponding image space grating and when modulating the SLM 104 to act as an object space grating. Thus, the general principle of using a shearing interferometer does not change, but a specialized “synthetic grating” in the object plane (i.e., the SLM 104) instead of a conventional grating is used.

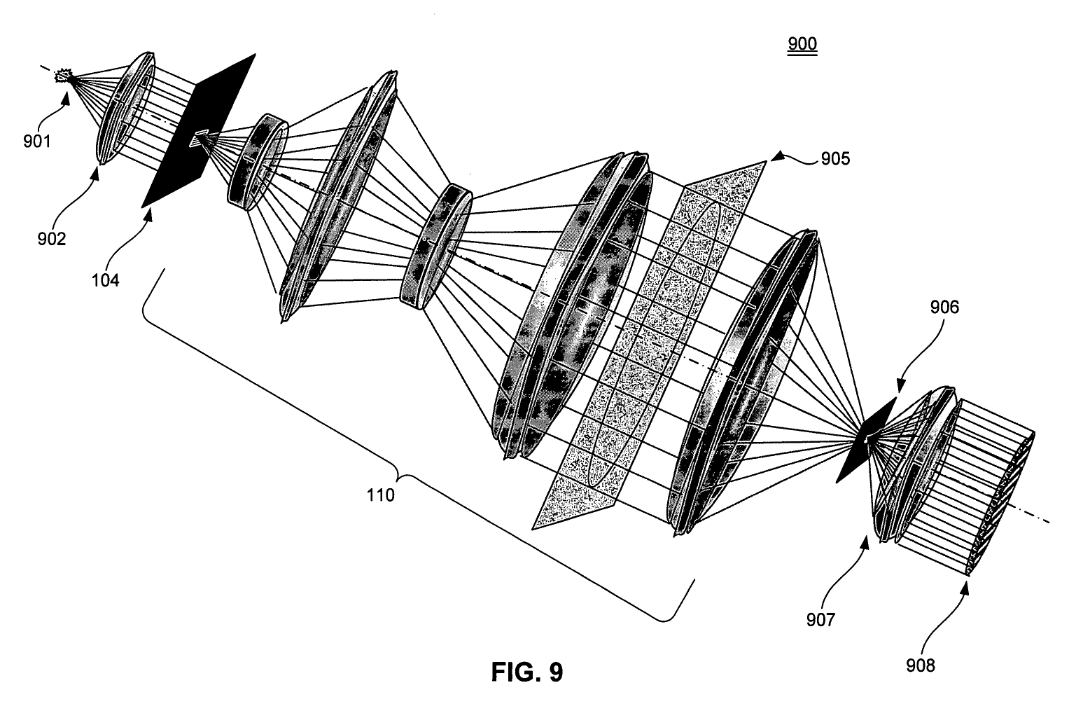

FIG. 9 illustrates an isometric view of the photolithographic system 100, with the system 100 being arranged for measurement of the PO 110 wavefront aberrations. As shown in FIG. 9, the system 100 includes an illumination source 901, a condenser lens 902, a transmissive-type SLM 104 (which acts as a synthetic grating, or as an extended object, and is located in the object plane), projection optics 110 with a pupil 905, an image plane shearing grating 906, a detector lens 907 and a CCD detector 908, arranged as shown in the figure. Also, although the SLM 104 is shown as a transmissive-type SLM in this figure, that need not always be the case.

The shearing grating 906 includes both transmissive and opaque regions. The opaque regions can be formed of materials that absorb the radiation wavelengths), such as nickel, chromium or other metals.

Typically, the SLM pixels will be turned either “on” or “off.” In a case of transmissive SLMs, the pixels will be either 100% transmissive, or 100% non-transmissive. In the case of reflective-type SLMs, the mirrors will be either oriented so as to either direct all the light into the numerical aperture of the projection optics 110 or to direct all the light away from the numerical aperture of the projection optics 110. In other words, the SLM 104 will appear to be formed of a number of bright lines (or “rulings,” or “stripes”) that direct light into the numerical aperture of the PO 110, and correspondingly, a number of dark lines that do not reflect (or transmit) light into the NA of the PO 110. Phrased another way, the SLM will appear to have a number of black and white stripes, that direct, or not direct, light into the numerical aperture of the PO 110. In effect, the SLM 104 will function as a synthetic object space grating.

The pitch of the grating 906 is chosen to provide an appropriate shear ratio, where the CCD detector 908 is in the fringe plane (i.e., below the focal, or image, plane of the projection optical system 110), and “sees” a pattern of fringes (an interferogram) or a number of overlapping circles, as will be discussed further below. The shear ratio is a measure of the overlap of two circles, where a shear ratio of zero represents perfect overlap. Note also that it is desirable for the CCD detector 908 to “see” only the zeroth order and the plus/minus first order diffraction images, and to eliminate the plus/minus second order diffraction images. A shear ratio of 1/30 is commonly used. Furthermore, the SLM 104 is modulated so as to aid in eliminating unwanted orders. It is important, however, that whichever pattern of modulation is used, that it be a regular pattern.

The pitch of the synthetic grating pattern of the SLM 104 is also preferably chosen to match the PO magnification times pitch of the shearing grating 906 so as to redistribute the light in the pupil to those locations that will mutually overlap as a result of shearing.

Furthermore, it is possible to use the SLM 104 to form orthogonal shear directions. If a particular direction is taken as the X direction in the XY plane (the XY plane being the object plane), and “grating rulings” are formed through SLM 104 modulation so as to be oriented parallel to the X direction, then it is straightforward to form similar rulings oriented in the direction. Thus, the same SLM 104 can be used to generate two orthogonal directions of shear.

Note that the pitch of the stripes, and therefore the dimension of the stripe in a direction orthogonal to the length of the stripe, depends on the magnification factor of the optics and the pitch of the image space grating 906. In practice, the dimension of the stripe in the direction orthogonal to the direction of the stripe is such that it is composed of a large number of mirrors, typically dozens or hundreds. This makes it possible to “translate” the synthetic grating in a lateral direction, or in a direction orthogonal to the orientation of the stripes. For example, if 100 pixels are used to form the stripe in an orthogonal direction, then by modulating the SLM 104 appropriately, the synthetic grating can “walk” laterally, as needed. This corresponds to phase shifting the fringe pattern in the plane of the detector 908. Phrased another way, this is analogous to moving an object space grating in a direction perpendicular to the rulings of the grating.

Depending on how many pixels are used to form each “ruling” or “stripe,” the same number of phase shifting steps are possible in the orthogonal direction. To move, or phase shift, the grating by one step, one row of pixels on a side of the stripe is turned on, and one row of pixels on the other side of the stripe is turned off. By repeating this process, the synthetic grating can “walk” laterally across object space. Alternatively, it is possible to “walk” the synthetic grating laterally by some multiple number of pixels at a time, for example, 3 pixels, or 10 pixels, or any other number of pixels at a time.

Note that if there is sufficient illumination from the source, even a single SLM pixel can be used as an object space grating. Alternatively, a “ruling” made up of a single row of pixels can also be used as an object space grating. However, it is expected that most practical applications will use several such synthetic “rulings” to form the synthetic grating.

Consider the following numerical example: the SLM 104 is 33 mm by 8 mm, and includes square pixels with L=16 μm on the side. The magnification of the PO 110 M=320×. A desired 1/30 shear ratio results in an image space grating with a pitch of 7.1 μm. The pitch of the synthetic grating in the object plane that is formed by the SLM 104 would be 7.1 μm×320=2.272 mm. The means that with 16 μm pixels, each “stripe” is about 142 pixels wide. Thus, in addition to phase-shifting, synthetic object space gratings of many different pitches, or gratings of same pitch but different angular orientation can be programmed. A related application (U.S. patent application Ser. No. 10/739,525, filed Dec. 19, 2003, entitled “Beam abberation sensor with matrix for different measurements,” incorporated by reference herein) proposes to use a matrix of shear gratings in the image plane, each grating different shear.

The above discussion applies to a light source 902 that is incoherent. If the light source is in fact partially coherent (which is often the case), this would cause a speckle phenomenon, which would result in higher order fringes being detected by the detector 908. To counteract the phenomenon of speckle, it is possible to modulate some (but not all) of the pixels in each stripe, so as to have a partially random distribution of reflection (or transmission) within each stripe. This will counteract the generation of speckle which is caused by the partial coherence of the illumination source.

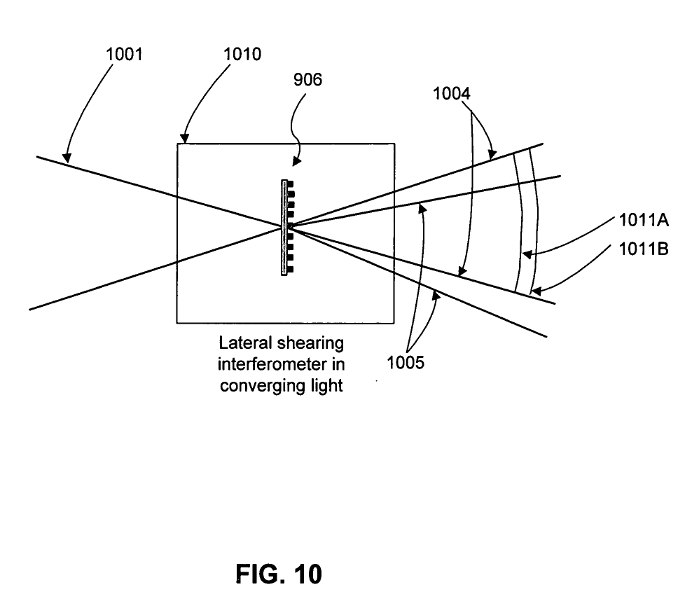

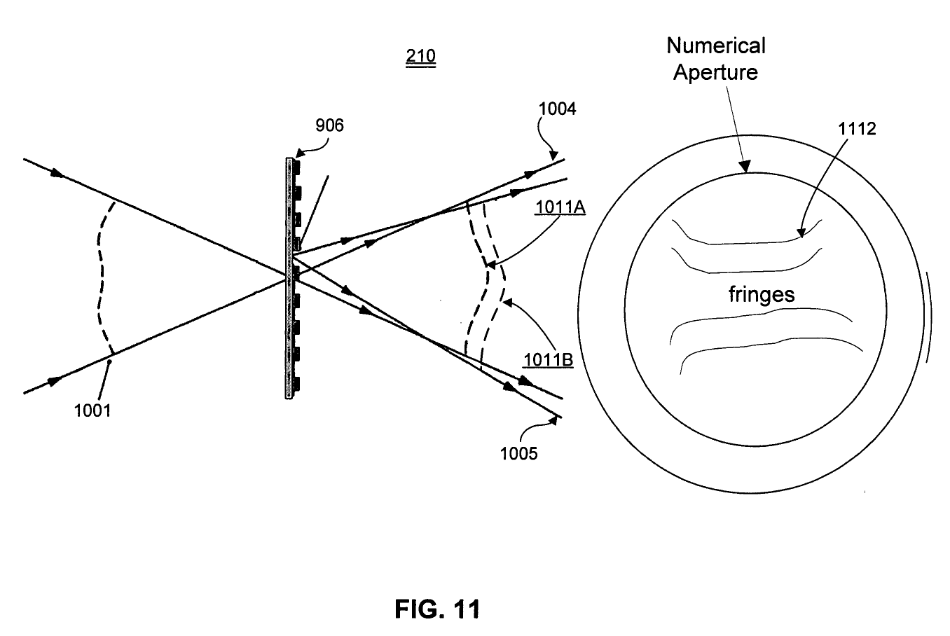

FIGS. 10 and 11 illustrate reference wavefronts and shear in a lateral shearing interferometer 1010. The lateral shearing interferometer 1010 interferes a wavefront 1001 with itself, or, phrased another way, it interferes a shifted copy of the wavefront 1001 with itself. As shown in FIGS. 10 and 11, the grating 906, positioned in the image plane, acts as a shearing interferometer, and generates a transmitted waves 1004 with a wavefront 1011A, and a diffracted reference wave 1005 with a wavefront 1011B. Thus, the lateral shearing interferometer 1010 creates one or more apparent sources, whose wavefronts 1011A, 1011B interfere to produce fringes 1112.

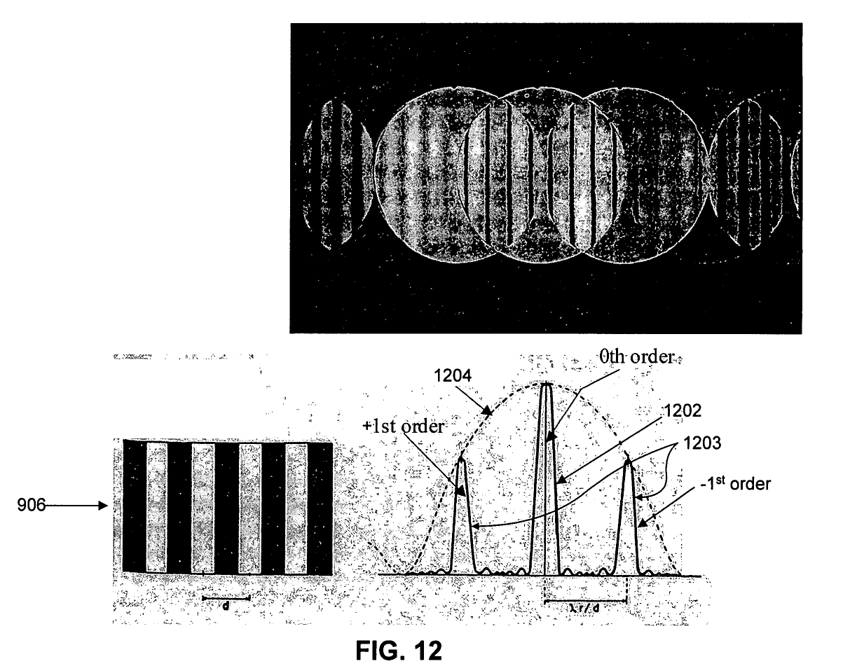

FIG. 12 illustrates the wavefront fringes (1112 in FIG. 11) as seen by the CCD detector 908. The width of the fringes 1112 is usually large compared to CCD pixels and imaged SLM pixels. As shown in FIG. 12, in the upper right-hand photograph, sheared fringes for a single object space slit are shown, where the slit is positioned in front of an incoherent, diffuse source that fills the maximum numerical aperture and smoothes any wavefront inhomogeneities. The bottom right-hand figure shows a fringe visibility function 1201, with zeroth order pattern 1202 and first order diffraction patterns 1203. The 50% duty cycle on the grating 906 makes all even orders of the diffraction pattern invisible. At the bottom left of FIG. 12, an exemplary the image space shearing grating 906 is shown.

Depending on the object-side numerical aperture (NA) of the projection optics 110 and the optical throughput requirements, it may be the case that the angular width of the diffraction pattern from the SLM 104 is small compared to the object-side NA of the PO 110. Preferably, SLM pixels are used either off or on. “On” pixels over-fill the pupil by design. That is, the 16μm SLM pixel is chosen to overfill the pupil. Smaller pixels as desirable would overfill even more. However, if a “on” pixel does not fill the pupil, it is still possible to dynamically fill the pupil. In that case, most of the light from this object ends up concentrated within a small area of the PO 110 pupil 905. Even for the highest pupil fills of the projection optics 110, the pupil 905 is still not completely filled, as is preferred for a complete aberration measurement. In this situation, the wavefront measurement methods will have very little sensitivity to the PO 110 aberrations occurring outside a relatively small illuminated area of the pupil 905. It is therefore preferred to fill the pupil 905 of the PO 110 more or less uniformly.

Thus, the problem of measuring wavefront aberrations has to balance two competing interests: filling the entire pupil 905 (but at the cost of very low intensity), or having sufficient intensity, but only on a small portion of the pupil 905.

A paper by Naulleau et al., Static Microfield Printing at the ALS with the ETS-2 Set Optic, Proc. SPIE 4688, 64-71 (2002) (http://goldberg.lbl.gov/papers/Naulleau_SPIE_{—}4688(2002).pdf), incorporated by reference herein, generally describes a dynamic pupil fill illumination system for EUV implemented in order to control partial coherence during printing at a synchrotron light source where illumination is coherent. The synthetic grating formed by the SLM 104 can be used to dynamically fill the pupil 905, since the beam from a single modulation state of the SLM 104 will typically not fill the entire pupil 905. However, by properly modulating the SLM to direct the beam across the pupil 905. Thus, using the approach described herein, the entire pupil 905 can be “swept” or dynamically filled as desired, so as to measure wavefront aberrations across the entire numerical aperture of the pupil 905.

The pupil fill by the SLM 104 can be achieved dynamically. During the measurement of the interferogram, the SLM 104 can be dynamically modulated, so that the diffraction pattern from the SLM 104 scans across the whole entrance pupil 905. The CCD detector 908 that measures the sheared interferogram integrates (or sums) the momentary interferograms occurring in the process of measurement.

The dynamic modification (modulation) of the SLM 104 is performed so that the transmittance (or reflectance) function of the SLM 104 has a time-dependent linear variation of the phase that ensures that the diffraction pattern from the SLM 104 is shifted within the pupil 905, dynamically sweeping the pupil 905 during the act of interferogram measurement.

The measurement of the interferogram is performed by the CCD detector 908 that records energy distribution across the CCD detector 908 plane. The CCD detector 908 is capable of integrating the time-varying intensity at every point in the detector 908 plane to collect a sufficient number of photons during the act of measurement. The CCD arrays used in present-day wavefront sensors (like the CCD detector 908) satisfy this requirement.

The present invention thus also applies to the situation when the size of the SLM 104 needed to ensure the required optical throughput is such that the characteristic width of the diffraction pattern from the SLM 104 is much less than the object side NA of the PO 110, i.e.,

$$\frac{λ}{SLM Size} ⪡ object side NA .$$

The SLM 104 can also be used, such that various regions on the grating have different grating pitch, and the grating is “walked” linearly in the object plane (i.e., perpendicular to the direction of the propagation of the electromagnetic radiation) so as to vary the direction of the beam (i.e., to scan it across the pupil 905). It is also important to realize that, depending on the particular type of SLM 104 used, the size of the pupil 905 and the scanning approach, maintaining proper focus in the image plane may become a problem, as the diffraction pattern is being scanned across the pupil 905. However, it is currently believed that although it is preferred to maintain focus, some de-focusing is acceptable.

The final sheared interferogram measured by the CCD detector 908 is a result of integration in time of the momentary sheared interferograms resulting from most of the light concentrated within a small portion of the pupil 905. The momentary sheared interferograms may have high contrast interference fringes only within a relatively small portion of the pupil image in the detector plane formed by the interfering diffraction orders. Their time integral measured by the CCD detector 908 has well-defined interference fringes across the whole pupil 905 that can be used (typically in conjunction with phase-stepping) to compute the wavefront aberration.

This is due to the fact that dynamic pupil fill described above is equivalent to the use of a stationary source corresponding to an actual source convolved with the dynamic movement (source scanning). Thus, regardless of the degree of coherence of illumination from the actual source, the effective source provides fully incoherent illumination.

The dynamic pupil fill using the SLM 104 also allows to fill the pupil 905 “tightly,” thus significantly reducing the loss of light that occurs with other methods. If necessary or desirable, the dynamic pupil fill allows sampling only the portions of the pupil 905 that are of interest.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A wavefront measurement system comprising:
a source of electromagnetic radiation;
an illumination system that directs the electromagnetic radiation to a spatial light modulator that produces a diffraction pattern;
a projection optical system that projects an image of the spatial light modulator onto an image plane;
a shearing grating in the image plane; and
a detector that receives a fringe pattern from the image plane.

2. The system of claim 1, wherein the spatial light modulator generates a non-linear phase variation across it to scan the diffraction pattern across a pupil of the projection optical system.

3. The system of claim 1, wherein the spatial light modulator scans the diffraction pattern across a pupil of the projection optical system.

4. The system of claim 1, wherein the diffraction pattern is dynamically scanned across a pupil of the projection optical system.

5. The system of claim 1, wherein the detector is located in a plane that is optically conjugate with a pupil of the projection optical system.

6. The system of claim 1, wherein the spatial light modulator forms a synthetic grating.

7. The system of claim 1, wherein spatial light modulator is a transmissive-type modulator.

8. The system of claim 1, wherein spatial light modulator is a reflective-type modulator.

9. The system of claim 1, wherein pixels of the spatial light modulator form rulings of a synthetic grating that have random variations of transmission within each ruling.

10. The system of claim 1, wherein pixels of the spatial light modulator form rulings of a synthetic grating that have random variations of angular orientation within each ruling.

11. The system of claim 1, wherein the spatial light modulator forms a synthetic grating, and wherein the spatial light modulator is adapted for simulating lateral movement of the synthetic grating.

12. The system of claim 1, wherein the spatial light modulator forms a synthetic grating having a plurality of possible orientations of its rulings.

13. A wavefront measurement system comprising:
an illumination system that delivers electromagnetic radiation to an object plane;
a spatial light modulator in the object plane that generates a diffracted beam of the electromagnetic radiation;
a projection optical system that projects the beam onto an image plane; and
a detector that receives a fringe pattern of the beam from the image plane.

14. The system of claim 13, wherein the spatial light modulator generates a non-linear phase variation across it to scan the diffracted beam across a pupil of the projection optical system.

15. The system of claim 13, wherein the spatial light modulator scans the diffracted beam across a pupil of the projection optical system.

16. The system of claim 13, wherein the diffracted beam is dynamically scanned across a pupil of the projection optical system.

17. The system of claim 13, wherein the detector is located in a plane that is optically conjugate with a pupil of the projection optical system.

18. The system of claim 13, wherein the spatial light modulator forms a synthetic grating.

19. The system of claim 13, wherein spatial light modulator is a transmissive-type modulator.

20. The system of claim 13, wherein spatial light modulator is a reflective-type modulator.

21. The system of claim 13, wherein pixels of the spatial light modulator form rulings of a synthetic grating that have random variations of transmission within each ruling.

22. The system of claim 13, wherein pixels of the spatial light modulator form rulings of a synthetic grating that have random variations of angular orientation within each ruling.

23. The system of claim 13, wherein the spatial light modulator forms a synthetic grating, and wherein the spatial light modulator is adapted for simulating lateral movement of the synthetic grating.

24. The system of claim 13, wherein the spatial light modulator forms a synthetic grating having a plurality of possible orientations of its rulings.

25. The system of claim 13, wherein the spatial light modulator forms a synthetic grating that changes its pitch to match a pitch of a grating in an image plane of the projection optical system.

26. The system of claim 13, wherein the spatial light modulator forms a synthetic grating that changes its orientation to match an orientation of a grating in an image plane of the projection optical system.

27. A method of measuring a wavefront of an optical system comprising:
generating electromagnetic radiation at a source;
delivering the electromagnetic radiation to a spatial light modulator;
forming a diffraction pattern at the spatial light modulator;
scanning the diffraction pattern across a pupil of an optical system;
receiving an image of the source; and
determining wavefront parameters from the image.

28. The method of claim 27, further comprising scanning the diffraction pattern across the pupil.

29. The method of claim 27, wherein the forming step comprises generating a non-linear phase variation across the spatial light modulator to scan the diffraction pattern across the pupil.

30. The method of claim 27, wherein the detector is located in a plane that is optically conjugate with the pupil.

31. The method of claim 27, further comprising forming a synthetic grating using the spatial light modulator.

32. The method of claim 30, further comprising changing a pitch of the synthetic grating to match a pitch of a grating in an image plane of the optical system.

33. The method of claim 30, further comprising changing an orientation of the synthetic grating to match an orientation of a grating in an image plane of the projection optical system.

34. The method of claim 27, wherein spatial light modulator is a transmissive-type modulator.

35. The method of claim 27, wherein spatial light modulator is a reflective-type modulator.

36. The method of claim 27, wherein the forming step comprises forming rulings of a synthetic grating that have random variations of transmission within each ruling.

37. The method of claim 27, wherein the forming step comprises forming rulings of a synthetic grating that have random variations of angular orientation within each ruling.

38. The method of claim 27, wherein the forming step comprises forming rulings of a synthetic grating, and wherein the forming step comprises simulating lateral movement of the synthetic grating.

39. The method of claim 27, wherein the forming step comprises forming a synthetic grating having a plurality of possible orientations of its rulings.

40. A method of measuring a wavefront of a projection optical system comprising:
(1) simulating a synthetic grating using the spatial light modulator;
(2) delivering electromagnetic radiation to a spatial light modulator positioned at an object plane of the projection optical system so as to generate a diffracted beam directed at the projection optical system;
(3) positioning a detector below an image plane of the projection optical system;
(4) receiving a fringe pattern of the diffracted beam at the detector; and
(5) calculating wavefront aberrations from the fringe pattern.
